(19) United States
(12) Patent Application Publication
(10) Pub. No.: US 2017/0223558 A1
(43) Pub. Date: Aug. 3, 2017

(54) METHODS AND APPARATUSES FOR MEASUREMENT ENHANCEMENT IN COMMUNICATION SYSTEM

(71) Applicant: ALCATEL LUCENT, Boullgne-Billamcourt (FR)

(72) Inventors: Yun Deng, Shanghai (CN); Chandrika Worrall, Newbury (GB)

(73) Assignee: Alcatel Lucent, Boulogne Billancourt (FR)

(21) Appl. No.: 15/500,596

(22) PCT Filed: Jul. 29, 2015
(86) PCT No.: PCT/IB2015/001482

§ 371 Date: Jan. 31, 2017

(30) Foreign Application Priority Data
Aug. 7, 2014 (CN) 201410386883.4

(51) Int. Cl. H04W 24/02; H04W 24/10

(52) U.S. Cl. CPC H04W 24/02; H04W 24/10

(57) ABSTRACT

Embodiments of the present invention relate to a method and apparatus for performing measurement enhancement for a cell in an off state. The method executed at a base station side comprises: transmitting a configuration message to a first device, wherein the configuration message indicates a specific time within a given time interval which can be used to perform measurement for one or more cells in the off state; and receiving a measurement report for the cell from the first device, wherein the measurement report is based on a result of a measurement performed by the first device for the cell at the specific time. Embodiments of the present invention further provide a method of UE corresponding thereto and a corresponding apparatus. The methods and apparatuses according to embodiments of the present invention can bring about enhanced small cell measurement so as to enable more effective use of the resources.

### FIELD OF INVENTION

Embodiments of the present invention relate to the technical field of wireless communications, and particularly to a method and apparatus for performing measurement enhancement for a cell in an off state.

### BACKGROUND OF THE INVENTION

A small cell, as a complement to a macro cellular network, aims to boost network capacity and enhance network coverage. At present, research about the small cell (or pico cell) is being carried out in the 3^{rd} Generation Partnership Project (3GPP).

A network including a micro cell and a small cell is also called a heterogeneous network (HetNet). Although the heterogeneous network has already been known as having advantages such as flexible in deployment, increasing capacity significantly and simple and convenient for coverage expansion, it brings challenges to interference management which cannot be ignored. In order to reduce interference and save power, an idea about turning off partial small cells has already been considered for small cells. In order to enable the small cell in the off state to be discovered by a user terminal (UE, or called user equipment) and be activated in time as needed for traffic, and to reduce the transition time from off to on, current research on long-term evolution-advanced (LTE-A) in 3GPP has already determined that the small cell in the off state will send discovery reference signal (DRS). Meanwhile, in order to achieve the purpose of interference reduction and power saving, transmission of the DRS is usually assumed as being much sparser than that of a cell-specific reference signal (CRS) in a cell of a normal state (on state).

Usually, a user terminal served by a cell in an on state measures signal quality of the present cell and meanwhile it is configured to perform measurement for neighboring cells. Thereby, quality of the signal from the neighboring cell to the UE is also made acquirable. This will facilitate implementation of a cell reselection caused by the UE's mobility, or cell handover performed for the sake of traffic load balancing, or link deterioration of the present cell, and guarantee the UE's communication quality. Generally, if the UE is configured with corresponding measurement configuration message (e.g., measurement identifier about the cell) for a certain neighboring cell, the UE may perform detection and measurement of signal quality of the cell based on PSS/SSS/CRS (Primary Synchronization Signal/Secondary Synchronization Signal/cell-specific reference signal) of the cell.

However, when the concept of off state of a cell is introduced, the neighboring cell to be measured by the UE might be a small cell in the off state, and the user terminal can only obtain the signal quality of the small cell by measuring the discovery reference signal DRS of the small cell.

The prior art does not disclose sufficient configuration message enabling the user terminal to perform DRS-based measurement effectively, e.g., the user terminal cannot determine whether an MBSFN subframe or uplink subframe is included within the duration time in which the small cell in the off state sends the DRS. That is to say, currently there is no effective design scheme about the configuration message, which enables the UE to perform effective measurement for the small cell in the off state according to the configuration.

In order to solve the above problem and improve measurement accuracy of the small cell in the off state, embodiments of the present invention provide a method and apparatus for enhancing measurement for the small cell in the off state. However, it should be appreciated that the method and apparatus also apply to other scenarios with similar problems, e.g., measurement of an apparatus in a dormant state.

### SUMMARY OF THE INVENTION

An object of embodiments of the present invention is to enhance measurement for a small cell.

According to a first aspect of embodiments of the present invention, the object is implemented by a method in a base station. The method comprises: transmitting configuration message to a first device, wherein the configuration message indicates a specific time within a given time interval which can be used for performing measurement for one or more cells in the off state; and receiving a measurement report for the cell from the first device, wherein the measurement report is based on a result of a measurement performed by the first device for the cell at the specific time.

According to an embodiment of the present invention, the configuration message indicates the specific time by indicating a Multicast Broadcast Single Frequency Network (MBSFN) subframe configuration for the cell or a frequency at which the cell lies.

According to a further embodiment of the present invention, the configuration message indicates the specific time by indicating whether the specific subframe within the given time interval is a MBSFN subframe for the cell or a frequency at which the cell lies.

According to a further embodiment of the present invention, the configuration message indicates the specific time by indicating whether a specific subframe within the given time interval includes a reference signal for measurement for the cell or a frequency at which the cell lies.

According to a further embodiment of the present invention, the configuration message indicates the specific time by indicating a time domain measurement resource restriction pattern for the cell or a frequency at which the cell lies.

According to a further embodiment of the present invention, the configuration message indicates the specific time by indicating a time division duplex (TDD) uplink/downlink allocation of the cell or the frequency at which the cell lies.

According to a further embodiment of the present invention, the configuration message indicates the specific time by indicating that a specific subframe within the given time interval is a downlink (DL) subframe or special subframe or uplink (UL) subframe for the cell or a frequency at which the cell lies.

According to some embodiments of the present invention, measurement is performed based on a discovery reference signal (DRS) of the cell, and the DRS includes a cell-specific reference signal (CRS), or includes the cell-specific reference signal and a channel state information reference signal (CSI-RS).

According to another embodiment of the present invention, the measurement means performing measurement for the cell at the indicated specific time according to the measurement configuration, and reporting a measurement report when measurement values of the one or more cells satisfy a reporting condition, wherein the measurement report includes a CRS measurement result of said one or more cells, or includes a CRS measurement result or a CSI-RS measurement result of said one or more cells.

According to another embodiment of the present invention, the configuration message is indicated in a measurement object corresponding to a frequency at which the cell lies; and the given time interval is a duration and a period in which the cell periodically transmits a discovery reference signal (DRS).

According to a second aspect of embodiments of the present invention, the object is implemented by a method in a UE. The method comprises receiving configuration message, wherein the configuration message indicates a specific time within a given time interval which can be used for performing measurement for one or more cells in the off state; determining the specific time at least partially based on the configuration message; and performing said measurement of said cell at the determined specific time.

The configuration message in this method may be the same as the configuration message described with respect to the first aspect of the present invention.

According to an embodiment of the present invention, the measurement is performed based on a discovery reference signal (DRS) of the cell, and the DRS includes a cell-specific reference signal (CRS), or includes the cell-specific reference signal and a channel state information reference signal (CSI-RS).

According to another embodiment of the present invention, the measurement means performing measurement for the cell at the indicated specific time according to the measurement configuration, and reporting a measurement report when measurement values of the one or more cells satisfy a reporting condition, wherein the measurement report includes a CRS measurement result of said one or more cells, or includes the CRS measurement result or a CSI-RS measurement result of said one or more cells.

According to a further embodiment of the present invention, the configuration message is indicated in a measurement object corresponding to a frequency at which the cell lies; and the given time interval is a duration and a period in which the cell periodically transmits a discovery reference signal (DRS).

According to a third aspect of embodiments of the present invention, the object is implemented by a base station for performing the method according to the first aspect of the present invention, comprising: a transmitting module configured to transmit a configuration message to a first device, wherein the configuration message indicates a specific time within a given time interval which can be used to perform measurement for one or more cells in the off state; and a first receiving module configured to receive a measurement report for the cell from the first device, wherein the measurement report is based on a result of a measurement performed by the first device for the cell at the specific time.

According to a fourth aspect of embodiments of the present invention, the object is implemented by an apparatus for performing the method according to the second aspect of the present invention, comprising: a second receiving module configured to receive a configuration message, wherein the configuration message indicates a specific time within a given time interval which can be used for performing measurement for one or more cells in the off state; a determining module configured to determine the specific time at least partially based on the configuration message; and a measuring module configured to perform said measurement of said cell at the determined specific time.

The method and apparatus disclosed in the embodiments of the present invention can enhance measurement for a small cell in the off state, potentially bring higher frequency spectrum efficiency, reduce interference, and improve the system performance.

### BRIEF DESCRIPTION OF DRAWINGS

The above and other features of the present disclosure will be made more apparent in the detailed description of embodiments of the present disclosure with reference to figures, wherein identical or like reference numbers denote identical or similar steps;

FIG. 1 illustrates a schematic view of an exemplary wireless communication system, in which embodiments of the present invention can be implemented;

FIG. 2 illustrates a flow chart of a method in a base station according to an embodiment of the present invention;

FIG. 3 illustrates a flow chart of a method in UE according to an embodiment of the present invention;

FIG. 4 illustrates a schematic block diagram of an apparatus according to an embodiment of the present invention;

FIG. 5 illustrates a schematic block diagram of another apparatus according to an embodiment of the present invention.

### DETAILED DESCRIPTION OF PREFERRED EMBODIMENTS

Exemplary aspects of the present invention will be described below. Specifically, the exemplary aspects of the present invention will be described below with reference to specific non-restrictive examples and content which may be currently considered as envisage-able embodiments the present invention. Those skilled in the art will appreciate that the present invention is by no means limited to these examples and may be applied more extensively.

It will be noted that the following exemplary description mainly relates to specifications used by non-restrictive examples given as exemplary network deployment. Specifically, the cellular communication network related to LTE (including LTE-advanced) is used as a non-restrictive example which applies the embodiment of the present invention. Furthermore, the exemplary example and depictions of embodiments given here specifically involve terminology directly relevant thereto. Such terminology is only used under the background of the presented non-restrictive examples and naturally does not limit the present invention in any manner. In fact, any other communication systems, frequency band, network configuration or system deployment may be utilized so long as they conform to feature described here compatibly.

Aspects, embodiments and implementation of the present invention will be described by using several alternatives. It should be noted that the described alternatives may be provided individually or provided in any envisage-able combination (also including combinations of individual features of various alternatives) according to certain requirements and constraints.

In the detailed depictions of optional embodiments, reference will be made to the accompanying drawings that constitute part of the present invention. The accompanying figures illustrate, in an exemplary manner, specific embodiments that can implement the present invention. The exemplary embodiments are not intended to exhaust all embodiments according to the present invention. Noticeably, although steps of the method in the present invention are described in a particular order herein, it does not require or imply that these operations must be performed according to this particular order, or a desired outcome can only be achieved by performing all the operations shown. On the contrary, the execution order for the steps as depicted herein may be varied. Additionally or alternatively, some steps may be omitted, a plurality of steps may be merged into one step, or a step may be divided into a plurality of steps for execution.

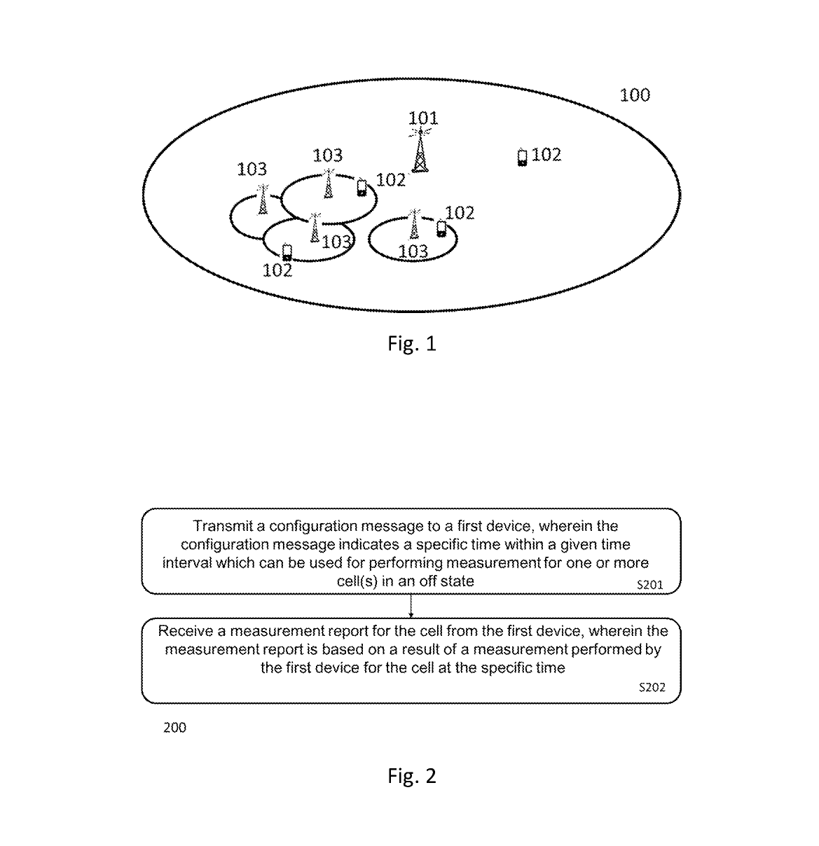

Reference is now made to FIG. 1 which is a schematic diagram of wireless communication network where an embodiment of the invention can be implemented. For illustrative purposes, the wireless communication network 100 is shown to be in a cellular structure. Those skilled in the art will appreciate, however, that embodiments of the invention also apply to non-cellular wireless communication networks, such as an ad hoc network, or D2D communication, as long as there is a similar problem about requiring enhancement to measurement of the network device in the off state. The wireless communication network comprises one or more macro cells each controlled by a base station 101, here for illustrative purpose, the macro base station is shown as a 3GPP LTE evolved node B (eNB or eNodeB). The base station may also take the form of a node B, a base station sub-systems (BSSs) or the like. The base station 101 provides radio connectivity to a plurality of user equipments (UEs) 102. The term “user equipment” is also known as mobile communication terminal, wireless terminal, mobile station, machine-to-machine communication device etc., and includes a mobile phone, a computer capable of wireless communication and the like. The network 100 depicted in FIG. 1 also comprises a number of small cells, each covered by a small cell base station 103 which has lower transmission power compared with the base station 101. The macro eNB 101 and the small cell base station 103 may communicate via a X2 interface, or any other suitable interfaces existing or to be developed in the future.

In order to reduce interference between the small cell and the macro cell and interference between the small cells, and to save power at the small cell base station, an idea about an off state has already been proposed. The small cell may dynamically switch between an on state and the off state to adapt to changes of the traffic state. In order to enable the small cell in the off state to be discovered by the user equipment and be activated in time as needed by traffic and to reduce the transition time from off to on, current research about long-term evolution-advanced (LTE-A) in 3GPP has already determined that the small cell in the off state will send discovery reference signal (DRS). According to 3GPP current agreement, the DRS includes PSS/SSS/CRS (Primary Synchronization Signal/Secondary Synchronization Signal/cell-specific reference signal), and may further comprise a channel state information reference signal (CSI-RS). The DRS signal may be sent with a certain period (e.g., 40 ms, 60 ms, 80 ms or the like), and only sent within a given time interval in each period, i.e., there is a time duration for sending DRS in each period; for example, there is a 6 ms transmission duration in each 80 ms (in this 6 ms, not every subframe has the DRS to be transmitted). For each small cell, a frequency and the time interval for transmitting the DRS may vary depending on its operating frequency, and DRS s of different small cells may also be identified according to different sequences of the reference signal used by it. The sequence is usually associated with a cell ID (identity) of the small cell, so that the UE can acquire the ID of the cell when DRS is detected.

Usually, a user terminal (UE) served by a cell (in the on state) performs measurement for signal quality of the present cell and meanwhile it is configured to perform measurement for neighboring cells. Thereby, quality of the signal from the neighboring cells to the UE is also made acquirable. This will facilitate implementation of cell reselection, which is caused by the UE's mobility, or by cell handover executed for the sake of traffic load balancing, or by link deterioration of the present cell, and guarantee the UE's communication quality. Generally, if the UE is configured with a corresponding measurement configuration message (e.g., measurement identifier about the cell) for a certain neighboring cell, the UE may perform detection and measurement of signal quality of the cell based on PSS/SSS/CRS of the cell.

When the small cell is in the off state, the user terminal can only measure the discovery reference signal (DRS) of the small cell to obtain the signal quality of the small cell. In order to accurately measure the discovery reference signal (DRS), the user terminal must obtain necessary information about the discovery reference signal (DRS), such as time interval for DRS transmission (duration and period for transmitting the DRS), amount of offset and possible transmission start time and the like, to enable the UE to perform DRS-based measurement.

The prior art does not disclose sufficient and necessary information which enables the UE to perform measurement based on the DRS effectively.

A document discussed in the 3GPP RAN1#77 meeting discloses some decisions about DRS in 3GPP. For example, UE can be configured with one DRS measurement timing configuration (DMTC) per frequency, which specifies a time period that might be used for performing DRS-based measurement, and this time period is for example determined by the DRS transmission configuration of the small cell. In this time period (e.g., 6 ms), the UE assumes that there is at least a CRS transmission from an antenna port 0. For a time division duplex (TDD) system, the UE can also assume that the CRS at least exists in a downlink subframe and a special subframe in this time period to perform a DRS-based measurement.

Regarding each measurement object (corresponding to a measurement frequency) of the base station configuration, it includes a neighboring cell configuration (neighCellConfig) message, which is used to provide configuration of the cell with respect to Multicast Broadcast Single Frequency Network (MBSFN) and time division duplex (TDD) UL/DL. However, it should be noted that currently the information in the neighboring cell configuration is not sufficient to enable the UE to perform effective DRS-based measurement.

A reason lies in that currently in the neighCellConfig, MBSFN configuration and TDD UL/DL configuration are only indicated by two bits, wherein,

00 indicates that not all neighbor cells have the same MBSFN subframe configuration as that of the serving cell (a primary cell or a secondary cell at the same frequency as the neighbor cell);

10 indicates that the MBSFN subframe configuration of all neighbour cells are identical to that of the serving cell (a primary cell or a secondary cell at the same frequency as the neighbor cell) or are a subset of it;

01 indicates that no MBSFN subframes are present in neighbour cells;

11 indicates UL/DL configurations in neighboring cells are different from that of the serving cell (a primary cell or a secondary cell at the same frequency as the neighbor cell).

The UE believes that DRS transmission does not exist in a MBSFN subframe in the small cell. Therefore, for a FDD system, when the neighbor cell configuration is set to be 00 or 10, the UE is not aware of which subframe in the neighbor cell is the MBSFN subframe, and correspondingly in this case, the UE cannot determine a DRS for measurement does not exist in which subframe.

The similar problem exists in the TDD system. The reason is that the DRS only exist in the downlink subframes, and when the neighbor cell configuration is set as 11, the UE will not be aware of which subframe in the neighbor cell is a DL subframe. For example, in the following table, depending on whether the TDD configuration is 0 or 5, the subframe 6 may be a special subframe or a normal DL subframe, whereas a subframe 7 may be UL or DL subframe. If the UE does not know TDD UL/DL configuration, in this case the UE cannot determine which subframe has the DRS for measurement and correspondingly a measurement error occurs. The measurement error might cause network misjudgment, e.g., cause wrong handover operation so as to cause reduction of system performance and degradation of UE's use experience.

TABLE 1
An Example of TDD UL/DL Configuration

| UL/DL | DL-UL Switch- | | | | | | | | | | |
|---|---|---|---|---|---|---|---|---|---|---|---|
| config- | point | Subframe number | | | | | | | | | |
| uration | periodicity | 0 | 1 | 2 | 3 | 4 | 5 | 6 | 7 | 8 | 9 |
| 0 | 5 ms | D | S | U | U | U | D | S | U | U | U |
| 5 | 10 ms | D | S | U | D | D | D | D | D | D | D |

The above problems will cause the UE's confusion in performing DRS-based measurement, cause inaccuracy of measurement and thereby affect performance of the whole system.

In order to solve the above problems and similar measurement issues existing in other systems, embodiments of the present invention provides a method and an apparatus.

Several exemplary embodiments of the present invention will be introduced with reference to the figures.

First, reference is made to FIG. 2. FIG. 2 illustrates a flow chart of a method 200 for enhancing measurement of a small cell in the off state according to an embodiment of the present invention. The method may be executed by a base station 101 in FIG. 1.

As shown in FIG. 2, the method 200 comprises a step S201 in which a base station serving a first device transmits a configuration message to a first device, wherein the configuration message indicates a specific time within a given time interval which can be used for performing measurement for one or more cells in the off state; and a step 202 of receiving a measurement report from the first device for the cell, wherein the measurement report is based on a result of a measurement performed by the first device for the cell at the specific time. Here the first device may be, for example, UE 102 shown in FIG. 1, and the measured cell may be a small cell controlled by the base station 103 in FIG. 1.

According to an embodiment of the present invention, the configuration message may be included in an existing measurement object message in the LTE, for example, be indicated by adding a new bit or field in the measurement object message. However, according to another embodiment, the configuration message may also be transferred via a new control message.

According to an embodiment of the present invention, before transmitting the configuration message in step S201, there is further included a step of the base station serving the first device communicating with the cell (or a base station controlling the cell) to obtain corresponding configuration of the cell. For example, this may be performed by using the X2 interface between base stations, or performed via an air interface. According to an embodiment of the present invention, in step S201 or before step S201, the base station serving the first device transmits measurement configuration to the first device, including measurement objects, measurement reporting conditions and so on.

According to different embodiments of the present invention, the configuration message transmitted in step S201 may be embodied in several different forms. For example, according to an embodiment, the configuration message indicates the specific time by indicating the Multicast Broadcast Single Frequency Network (MBSFN) subframe configuration for the cell or a frequency at which the cell lies. The MBSFN subframe configuration here is more detailed than the configuration message currently contained in the neighCellConfig, for example, instead of indicating whether it is the same as or different from the configuration of the serving cell, it specifies a specific configuration of the MBSFN subframe for the cell or the frequency at which the cell lies. For example, it may indicate an index of the MBSFN subframe configuration for the frequency, and the index is directed to a specific configuration in an MBSFN configuration set, i.e., indicates which subframe is used as a MBSFN subframe. Since DRS is not transmitted in a MBSFN subframe, this at least partially provides an indication of which subframes do not contain the DRS. Regarding those non-MBSFN subframes, a DRS measurement timing configuration (DMTC) can be utilized to further indicate whether DRS transmission exists therein, i.e., whether it can be used for DRS measurement. For example, if one subframe is not configured as a MBSFN subframe according to the configuration message, and meanwhile the subframe is a subframe used for DRS measurement according to DMTC, then UE may determine that the DRS measurement can be performed on the subframe. Although the specific time is described as a specific subframe in the embodiment, it should be appreciated that the specific time may also be other time representation, e.g., may be a specific symbol, depending on different systems to which embodiments of the present invention are applied; therefore, embodiments of the present invention are not limited to this.

According to another embodiment, the configuration message in step S201 may not indicate an entire MBSFN subframe configuration for the cell or a frequency at which the cell lies, but only indicate whether a specific subframe within the given time inverval is a MBSFN subframe for the cell or the frequency at which the cell lies, and thereby indicate the specific time which can be used for performing measurement for one or more cells in the off state. The given time interval here is a duration and a period at which the cell in the off state transmits the discovery reference signal (DRS) periodically, e.g., 6 ms DRS transmission duration in each 80 m cycle. It should be noted that, there may not be DRS transmission in every subframe in the 6 ms DRS transmission duration, it is possible that not every has DRS for transmission. If there is MBSFN subframe or uplink subframe in this 6 ms, no DRS is transmitted in the MBSFN subframe or uplink subframe. The given time interval, for example, may be indicated by the DMTC. The DMTC may be transmitted through step S201 or transmitted to the UE in other steps not shown in FIG. 2. For example, if the DMTC specifies that the DRS transmission duration is 4 subframes (4 ms), according to the embodiment, the base station may indicate in the configuration message which subframe of the four subframes is a MBSFN subframe. This indication may be represented by a 4-bit bitmap.

In another embodiment, the configuration message in step S201 may explicitly indicate whether the specific subframe within the given time interval (e.g., the DRS duration designated by the DMTC) includes a reference signal for measurement for the cell or the frequency at which the cell lies. For example, for a DRS with a duration of 4 subframes, the configuration message may indicate which subframe(s) within the four subframes does (not) have the DRS. Thereby, the UE can determine the specific time performing measurement for one or more cells in the off state on this basis. For example, if the information indicates 1101, wherein it is assumed that 1 indicate presence of the DRS, then the UE can determine that the DRS transmission exists in the first two subframes and the last subframe within the four subframes, and the UE can perform DRS measurement.

In a further embodiment, it is assumed that the cell adopts enhanced interference management and traffic adaptation (eIMTA) technology, and a time domain measurement restriction is configured for purpose of interference control, in this case, in step S201 a time domain measurement resource restriction pattern indication of the cell may be transmitted to the UE as configuration information. For example, if it is specified for the UE through DRS configuration message or DMTC that subframes 0-5 are the DRS duration, and then configuration information is further transmitted in step S201 to indicate a time domain measurement resource restriction pattern of the cell to be measured or the frequency at which the cell lies, and the pattern indicates that subframe 5 cannot be used for measurement, in this case, the UE can determine that only subframes 1-4 can be used to perform measurement for one or more cells in the off state.

According to a further embodiment, the configuration message in step S201 indicates the specific time by indicating the time division duplex (TDD) uplink/downlink (UL/DL) configuration of the cell to be measured or the frequency at which the cell lies, for example, indicating one of seven TDD configurations adopted in LTE. Since the DRS does not exist in the UL subframe, the UL/DL configuration message enables the UE to avoid unnecessary measurement for the UL subframe, save power and meanwhile improve measurement precision.

Also for the TDD system, an alternative solution is that the configuration message in step S201 directly indicates that a specific subframe within the given time interval is a downlink subframe or a special subframe or a uplink subframe for the cell to be measured or the frequency at which the cell to be measured lies. This achieves the same effect as indicating TDD UL/DL. Furthermore, this allows more flexible TDD configuration, for example, not limited to the current seven TDD configurations.

In a further embodiment, for purpose of traffic self-adaptation for the TDD system, the serving cell of the UE can dynamically adjust the UL/DL configuration of the cell via a physical layer signaling. It is assumed that in the case the neighCellConfig is configured as 00, 01 or 10, i.e., the neighbor cell adopts the same UL/DL configuration as that of the serving cell, in this case the physical layer signaling (adjusting the UL/DL configuration of the serving cell) may be used as the configuration message in step S201. This information can also help the UE to determine whether a specific subframe in the off state small cell (identical with the UL/DL configuration of the adjusted serving cell) to be measured includes the DRS.

In accordance with a further embodiment of the present invention, the configuration message may be a combination of various configuration messages described in the above embodiments. For example, it may simultaneously indicate the MBSFN configuration and TDD UL/DL configuration. The configuration message is indicated in a measurement object corresponding to the frequency at which the cell lies.

According to another embodiment of the present invention, the configuration message may be configured independently for each neighbor cell or the frequency at which each neighbor cell lies, i.e., configured individually for each neighbor cell, or configured individually for the frequency at which each neighbor cell lies. Correspondingly, it can adapt to flexible cell configuration.

According to an embodiment of the present invention, after transmitting the configuration message, the base station will assume that the measurement report received in step S202 is performed based on the specific time of the step S201.

According to an embodiment of the present invention, the measurement is performed based on the discovery reference signal (DRS) of the cell, and the DRS includes a cell-specific reference signal (CRS), or includes the cell-specific reference signal and the channel state information reference signal (CSI-RS). According to another embodiment, the measurement means that the device performs measurement for the cell at the indicated specific time according to the measurement configuration; furthermore, according to an embodiment, the measurement report received in step S202 of the method is reported only when measurement values of the one or more cells satisfy a reporting condition, the measurement report includes CRS measurement results of said one or more cells, or includes CRS measurement result or CSI-RS measurement result of said one or more cells (in one measurement report). In the present invention, the measurement result may be reference signal received power (RSRP) and/or reference signal received quality (RSRQ). The base station, after obtaining the measurement report, may make a decision on whether it is necessary to handover the UE to the cell, to facilitate boost of the system capacity.

According to an embodiment of the present invention, the configuration message is indicated in the measurement object corresponding to the frequency at which the cell lies; according to a further embodiment, the given time interval is the duration and period at which the cell periodically transmits the discovery reference signal (DRS).

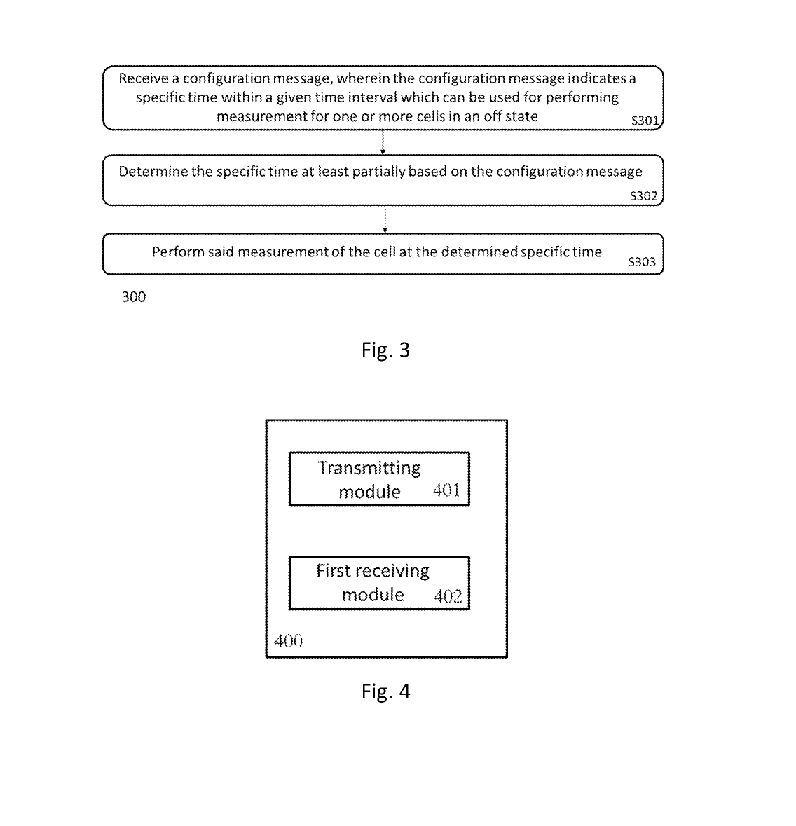

Now reference is made to FIG. 3. FIG. 3 illustrates a flow chart of a method 300 at a measurement-performing device, for enhancing measurement of a small cell in the off state according to an embodiment of the present invention. The method may be implemented by, for example, UE 102 in FIG. 1.

As shown in FIG. 3, the method 300 comprises a step 301 of receiving configuration message from the base station, wherein the configuration message indicates a specific time within a given time interval, the specific time can be used for performing measurement for one or more cells in the off state; a step S302 of determining the specific time at least partially based on the configuration message; and step S303 of performing said measurement of said cell at the determined specific time.

According to an embodiment of the present invention, the configuration message in step S301 may come from for example a macro base station 101 shown in FIG. 1. The base station executes any method described with reference to FIG. 2. Therefore, implementations of various configuration messages described above with reference to FIG. 2 also apply here and will not be detailed.

In some embodiments of the present invention, the determination performed in step S302 is based on the configuration message, and may be further based on other control parameters, such as DRS configuration of the small cell, including period, time domain offset, duration and the like, and might include a measurement interval configured by the base station.

According to an embodiment of the present invention, measurement of the small cell in the off state is performed based on DRS, the DRS includes a cell-specific reference signal (CRS), or includes the cell-specific reference signal and the channel state information reference signal (CSI-RS). According to another embodiment, the measurement means that the device performs measurement for the cell at the indicated specific time according to the measurement configuration; furthermore, according to an embodiment, the method 300 further includes a step of reporting a measurement report when measurement values of the one or more cells satisfy a reporting condition, the measurement report includes a result of the measurement performed in step S303, which includes CRS measurement results of said one or more cells, or includes CRS measurement result or CSI-RS measurement result of said one or more cells.

In an embodiment of the present invention, the configuration message is indicated in the measurement object corresponding to the frequency at which the cell lies. In a further embodiment, the given time interval for measurement is the duration and period at which the cell periodically transmits the discovery reference signal (DRS). At least partially based on the configuration message received in step S301, the UE determines which specific time (subframe) within the given time interval may be used for or suitable for measurement of a certain small cell so as to make the measurement more accurate.

It should be noted that embodiments of the present invention are mainly described in the context of a small cell in the off state in LTE. However, it should be appreciated that the described embodiments can also be applied to other scenarios. For example, it can be applied to measurement of an device in a dormant state in D2D. Hence, the present invention should not be construed as being limited to the illustrated exemplary embodiments.

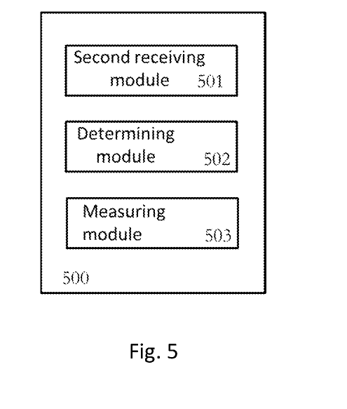

Block diagrams for an embodiment of an apparatus for implementing a method of improving cell measurement are described in the following with reference to FIGS. 4-5 respectively. The apparatus is also exemplary and only components closely related to the present invention are shown. It should be appreciated that the apparatus may further comprise components for other functions besides what are shown.

The apparatus 400 shown in FIG. 4 can be used to execute the method described with reference to FIG. 2, but not limited to these methods; likewise, the method described with reference to 2 may be implemented by the apparatus, but not limited to be implemented by the apparatus 400. The apparatus 400 may be for example the macro base station 101 shown in FIG. 1.

As shown in FIG. 4, the apparatus 400 comprises a transmitting module 401 configured to transmit configuration message to a first device, wherein the configuration message indicates a specific time within a given time interval which can be used to perform measurement for one or more cells in the off state; and a first receiving module 402 configured to receive a measurement report from the first device for the cell, wherein the measurement report is based on a result of a measurement performed by the first device for the cell at the specific time, wherein the first device may be, for example, UE 102 shown in FIG. 1, and the measured cell may be a small cell controlled by the base station 103 in FIG. 1.

The implementation of various configuration messages described above with reference to FIG. 2 is also applicable for the configuration message transmitted by the transmitting module 401 and will not be detailed here. Only several examples are given for illustration.

For example, the transmitting module 401 may be configured to transmit the configuration message in an existing measurement object message in LTE, for example, indicate the specific time by adding a new bit or field in the measurement object message. However, according to another embodiment, the transmitting module may be configured to transfer an indication of the specific time by a new control message.

According to an embodiment of the present invention, the transmitting module 401 may be configured to indicate the specific time by transmitting information to indicate the Multicast Broadcast Single Frequency Network (MBSFN) subframe configuration for one or more cells or a frequency at which the one or more cells lie.

According to another embodiment of the present invention, the transmitting module 401 may be configured to transmit information to indicate whether a specific subframe within the given time interval is a MBSFN subframe for the cell or the frequency at which the cell lies, and thereby indicate the specific time which can be used to perform measurement for one or more cells in the off state. The given time interval may be transmitted to the UE via a DMTC message, and the transmission may be accomplished by other transmitting modules or likewise by the transmitting module 401.

In a further embodiment, the transmitting module 401 may be configured to transmit information to explicitly indicate whether a specific subframe within the given time interval (e.g., a duration specified by the DMTC) includes a reference signal for measurement, namely, the DRS signal, for the cell or the frequency at which the cell lies.

In a further embodiment, the transmitting module 401 may be configured to transmit information to indicate a time domain measurement resource restriction pattern of the cell or the frequency at which the cell lies, thereby partially indicating the specific time which can be used to perform measurement for one or more cells in the off state.

In a further embodiment, the transmitting module 401 may be configured to transmit configuration message to indicate a time division duplex (TDD) uplink/downlink (UL/DL) configuration of the cell to be measured or the frequency at which the cell to be measured lies, thereby indicating the specific time. Also for the TDD system, an alternative solution is that the transmitting module 401 may be configured to transmit information to directly indicate that a specific subframe within the given time interval is a downlink subframe or a special subframe or a uplink subframe for the cell to be measured or the frequency at which the cell to be measured lies.

In a further embodiment, for the TDD system, the transmitting module 401 may be configured to provide information about the specific time which can be used to perform measurement for one or more cells in the off state by transmitting physical layer TDD uplink/downlink (UL/DL) (re) configuration information.

According to a further embodiment of the present invention, the transmitting module 401 may be configured to transmit a combination of various configuration messages described in the above embodiments. According to a further embodiment of the present invention, the configuration message may be configured independently for each neighbor cell or the frequency at which each neighbor cell lies, i.e., the configuration message may vary with each neighbor cell or the frequency at which each neighbor cell lies, so as to adapt to flexible cell configurations.

Referring to FIG. 5 now, the apparatus 500 shown in FIG. 5 can be used to implement the method described with reference to FIG. 3, but not limited to these methods; likewise, the method described with reference to FIG. 3 may be executed by the apparatus, but not limited to being implemented by the apparatus 500. The apparatus 500 may be for example the UE 102 shown in FIG. 1.

As shown in FIG. 5, the apparatus 500 comprises a second receiving module 501 configured to receive configuration message from the base station, wherein the configuration message indicates a specific time within a given time interval which can be used to perform measurement for one or more cells in the off state; a determining module 502 configured to determine the specific time at least partially based on the configuration message; and a measuring module 503 configured to perform said measurement of said cell at the determined specific time.

As the configuration message received by the receiving module of the apparatus 500 may be transmitted by the apparatus 400 implementing the method shown in FIG. 2, various implementations of configuration messages described above with reference to FIG. 2 and FIG. 4 also apply here and therefore will not be detailed.

The determining module 502 may be configured to perform functions of the step S302 described with reference to FIG. 3. According to an embodiment, the determining module 502 may be configured to determine the specific time that is used to perform measurement for one or more cells in the off state based on the configuration message, and in another embodiment, can be further configured to determine the specific time based on other control parameters in addition to the configuration message, for example, the DRS configuration of the small cell, including period, time domain offset, duration and the like, and may further include a measurement interval parameter configured by the base station.

According to an embodiment of the present invention, measurement of the small cell in the off state performed by the measuring module 503 is based on the DRS, the DRS includes a cell-specific reference signal (CRS), or includes the cell-specific reference signal and the channel state information reference signal (CSI-RS). According to another embodiment, the measurement performed by the measuring module 503 means that the apparatus performs measurement for the cell at the indicated specific time according to the measurement configuration; furthermore, according to an embodiment, the measuring module is further configured to report a measurement report when measurement values of the one or more cells satisfy a reporting condition, the measurement report includes CRS measurement results of said one or more cells, or includes CRS measurement result or CSI-RS measurement result of said one or more cells.

According to an embodiment of the present invention, the configuration message is indicated in the measurement object corresponding to the frequency at which the cell lies. In a further embodiment, the given time interval for measurement is the duration and period in which the cell periodically transmits the discovery reference signal (DRS). At least partially based on the configuration message received by the receiving module 501, the determining module 502 determines which specific time (subframe) within the given time interval may be used for or suitable for measurement of a certain small cell so as to make the measurement of the measuring module 503 more accurate.

Depictions of exemplary embodiments provided herein are presented above for illustration purpose. The depictions are not intended to exhaust embodiments or limit exemplary embodiments to the exact forms being disclosed, and various modifications and variations may be made according to the above teaching. The Examples discussed herein are selected and described to explain various exemplary embodiments and their principles and characteristics upon actual application, to enable those skilled in the art to use the exemplary embodiments in various manners and make them adapted to various modifications for envisaged specific use. Features of the embodiments described herein may be combined in all possible combinations of method, apparatus, module, system and computer program product. It should be appreciated that the exemplary embodiments given herein may be implemented in any combination forms.

It should be noted that the word “comprise” does not certainly exclude existence of other elements or steps besides those as listed, and word “a” before an element does not exclude existence of a plurality of such elements. It should be further noted that any reference sign does not limit the scope of claims, the exemplary embodiments may at least partially be implemented through hardware and software, and a plurality of “devices”, “units” or “apparatuses” may be represented by the same hardware item. Besides, obviously the word “include” does not exclude other elements and steps, and the word “a” does not exclude plurality. A plurality of elements recited in an apparatus claim may be implemented by one element. Words such as “first” and “second” are used to indicate names and do not indicate any specific order.

The term “user equipment” used herein should be understood generally, it may comprise wireless telephone or personal digital assistant (PDA) of a wireless communication system; laptop computer; a camera (e.g., video and/or still image camera) having communication capability; and any other computing or communication device that can perform transmitting an receiving, such as personal computer, home entertainment system and TV set.

Although the user equipment is mainly described as a measuring or recording unit, those skilled in the art should understand that “user equipment” is a non-restrictive term, and it means any wireless device or node (such as PDA, laptop computer, mobile device, sensor, fixed relay, mobile relay or even radio base station such as pico base station) that can perform reception in DL and perform transmission in UL.

The cell is associated with a radio node, and it, generally, includes any node for transmitting radio signal for measurement, e.g., eNodeB, macro eNodeB/microcell/picocell, home eNodeB, relay, radio beacon facility or repeater. The radio node here may comprise a radio node performing operation in one or more frequencies or frequency bands, it may be a radio node having CA capability, and it may be single RAT or multi-RAT node. The multi-RAT node may comprise a node with co-located RATs or a node supporting multiple standard radio (MSR) or a mixed radio node.

Various exemplary embodiments describe herein in the context of steps or processing of a method may be, on the one hand, implemented by a computer program product embodied in a computer readable medium. Computer-executable instructions, associated data structures and program modules represent examples of program codes for executing steps of the method disclosed herein. A specific sequence of such executable instructions or associated data structures represents an example of a corresponding action for implementing a function described in such step or processing.

Hence, those skilled in the art appreciate that obviously the present invention is not limited to details of the above exemplary embodiments, and instead, the present invention can be implemented in other specific forms without departing from the spirit or basic features of the present invention. In any way, embodiments should all be regarded as being exemplary and non-restrictive.

1. A method for measurement enhancement in a communication system, comprising:
transmitting a configuration message to a first device, wherein the configuration message indicates a specific time within a given time interval which can be used for performing measurement for one or more cell(s) in an off state; and
receiving a measurement report for the cell from the first device, wherein the measurement report is based on a result of a measurement performed by the first device for the cell at the specific time.

2. The method according to claim 1, wherein the configuration message indicates the specific time by indicating at least one of the following:
a Multicast Broadcast Single Frequency Network (MBSFN) subframe configuration for the cell or a frequency at which the cell lies;
whether a specific subframe within the given time interval is a MBSFN subframe for the cell or the frequency at which the cell lies;
whether a specific subframe within the given time interval includes a reference signal for the measurement for the cell or the frequency at which the cell lies;
a time domain measurement resource restriction pattern for the cell or the frequency at which the cell lies;
a time division duplex (TDD) uplink/downlink allocation of the cell; and
a specific subframe within the given time interval is a downlink subframe or a special subframe or an uplink subframe for the cell or the frequency at which the cell lies.

3.-7. (canceled)

8. The method according to claim 1, wherein the measurement is performed based on a discovery reference signal (DRS) sent from the cell, and the discovery reference signal includes a cell-specific reference signal (CRS), or includes the cell-specific reference signal and a channel state information reference signal (CSI-RS).

9. (canceled)

10. The method according to claim 1, wherein the configuration message is indicated in a measurement object corresponding to a frequency at which the cell lies; and the given time interval is a duration and a period in which the cell periodically transmits a discovery reference signal (DRS).

11. A method for measurement enhancement in a communication system, comprising:
receiving a configuration message, wherein the configuration message indicates a specific time within a given time interval which can be used for performing measurement for one or more cells in an off state;
determining the specific time at least partially based on the configuration message; and
performing said measurement of the cell at the determined specific time.

12. The method according to claim 11, wherein the configuration message indicates the specific time by indicating at least one of the following:
a Multicast Broadcast Single Frequency Network (MBSFN) subframe configuration for the cell or a frequency at which the cell lies;
whether a specific subframe within the given time interval is a MBSFN subframe for the cell or the frequency at which the cell lies;
whether the specific subframe within the given time interval includes a reference signal for measurement for the cell or the frequency at which the cell lies;
a time domain measurement resource restriction pattern for the cell or the frequency at which the cell lies;
a time division duplex (TDD) uplink/downlink allocation for the cell or the frequency at which the cell lies; and
a specific subframe within the given time interval is a downlink subframe or a special subframe or an uplink subframe for the cell or the frequency at which the cell lies.

13.-17. (canceled)

18. The method according to claim 11, wherein the measurement is performed based on a discovery reference signal (DRS) sent from the cell, and the discovery reference signal includes a cell-specific reference signal (CRS), or includes the cell-specific reference signal and a channel state information reference signal (CSI-RS).

19. (canceled)

20. The method according to claim 11, wherein the configuration message is indicated in a measurement object corresponding to a frequency at which the cell lies; and the given time interval is a duration and a period in which the cell periodically transmits a discovery reference signal (DRS).

21. An apparatus for measurement enhancement in a communication system, comprising:
a transmitting module configured to transmit a configuration message to a first device, wherein the configuration message indicates a specific time within a given time interval which can be used for performing measurement for one or more cell(s) in the off state; and
a first receiving module configured to receive a measurement report for the cell from the first device, wherein the measurement report is based on a result of a measurement performed by the first device for the cell at the specific time.

22. The apparatus according to claim 21, wherein the transmitting module is configured to indicate the specific time by transmitting a configuration message indicating at least one of the following:
a Multicast Broadcast Single Frequency Network (MBSFN) subframe configuration for the cell or a frequency where the cell lies;
whether a specific subframe within the given time interval is the MBSFN subframe for the cell or the frequency at which the cell lies;
whether a specific subframe within the given time interval is the MBSFN subframe for the cell or the frequency at which the cell lies;
a time domain measurement resource restriction pattern for the cell or the frequency at which the cell lies;
a time division duplex (TDD) uplink/downlink allocation for the cell or a frequency at which the cell lies; and
a specific subframe within the given time interval is a downlink subframe, a special subframe or an uplink subframe for the cell or a frequency at which the cell lies.

23.-27. (canceled)

28. The apparatus according to claim 21, wherein the measurement is performed based on a discovery reference signal (DRS) transmitted from the cell, and the discovery reference signal includes a cell-specific reference signal (CRS), or includes the cell-specific reference signal and a channel state information reference signal (CSI-RS).

29. (canceled)

30. The apparatus according to claim 21, wherein the configuration message is indicated in a measurement object corresponding to a frequency at which the cell lies; and the given time interval is a duration and a period in which the cell periodically transmits a discovery reference signal (DRS).

31. An apparatus for measurement enhancement in a communication system, comprising:
a second receiving module configured to receive a configuration message, wherein the configuration message indicates a specific time within a given time interval which can be used for performing measurement for one or more cells in an off state;
a determining module configured to determine the specific time at least partially based on the configuration message; and
a measuring module configured to perform said measurement of said cell at the determined specific time.

32. The apparatus according to claim 31, wherein the configuration message indicates the specific time by indicating at least one of:
a Multicast Broadcast Single Frequency Network (MBSFN) subframe configuration for the cell or a frequency at which the cell lies;
whether a specific subframe within the given time interval is a MBSFN subframe for the cell or a frequency at which the cell lies;
whether a specific subframe within the given time interval includes a reference signal for measurement for the cell or a frequency at which the cell lies
a time domain measurement resource restriction pattern for the cell or a frequency at which the cell lies;
a time division duplex (TDD) uplink/downlink allocation for the cell or a frequency at which the cell lies; and
a specific subframe within the given time interval is a downlink subframe, a special subframe or an uplink subframe for the cell or a frequency at which the cell lies.

33.-37. (canceled)

38. The apparatus according to claim 31, wherein the measurement is performed based on a discovery reference signal (DRS) of the cell, and the discovery reference signal includes a cell-specific reference signal (CRS), or includes the cell-specific reference signal and a channel state information reference signal (CSI-RS).

39.-40. (canceled)
